(19) United States
(12) Patent Application Publication
(10) Pub. No.: US 2017/0356577 A1
(43) Pub. Date: Dec. 14, 2017

(54) Joint Restraint

(71) Applicant: The Ford Meter Box Company, Inc., Wabash, IN (US)

(72) Inventors: Hans Christian Lassen, Pell City, AL (US); Adam Stacey Pennington, Talladega, AL (US); Zachary J. Gentile, JR., Trussville, AL (US); Earl Sinjon Bradberry, Vestavia Hills, AL (US)

(21) Appl. No.: 15/621,115

(22) Filed: Jun. 13, 2017

Related U.S. Application Data
(60) Provisional application No. 62/349,806, filed on Jun. 14, 2016.

(51) Int. Cl. F16L 23/032

(52) U.S. Cl. CPC F16L 23/032

(57) ABSTRACT

A joint restraint assembly illustratively includes a substantially annular body that includes an opening disposed there through to fit around the pipe. Two or more pockets that each receive a segment configured to engage a portion of the outside surface of the pipe. The segments are spaced apart from each other. A portion of the substantially annular body extends toward the opening between each of the segments to occupy space between the segments to inhibit deformation of the pipe at the joint restraint assembly.

### RELATED APPLICATIONS

The present application relates to and claims priority to U.S. Provisional Patent Application Ser. No. 62/349,806, filed on Jun. 14, 2016. The subject matter disclosed in that provisional application is hereby expressly incorporated into the present application in its entirety.

### TECHNICAL FIELD AND SUMMARY

The present disclosure relates to joint restraint assemblies, and particularly to wedge/segment activated joint restraint assemblies that include spacers located between consecutive segments that fills space between an outer periphery of the pipe and the joint restraint assembly gland.

Joint restraint assemblies for connecting pipes together are known in the water works industry. Such joint restraint assemblies typically comprise an annular body or gland that fits about and secures to the outer periphery or surface of a pipe. This gland includes bolt holes oriented parallel to the pipe. When the glands are affixed to the connecting pipes, bolts may be inserted through the bolt hole openings of each gland, run parallel to the pipe, fastening to the glands, thereby coupling the two pipes together. These bolt openings are typically evenly spaced on each gland to distribute the coupling forces generally evenly. An example of a joint restraint assembly is shown in U.S. Pat. No. 6,322,273 ('273 patent), titled “Joint Restraint Assembly”, the disclosure of which is incorporated herein in its entirety by reference.

As shown in FIGS. 1 and 2 of the '273 patent, the joint restraint assembly includes a gland having six-segments spaced evenly about the pipe joint opening to grip the pipe on approximately 75% of the peripheral surface of the pipe. This is further demonstrated in PRIOR ART FIG. 1 shown herein.

Since development of the six-segment joint restraint assembly, alternate joint restraint assemblies comprising a gland having 2, 3, 4, 6, 8, 10, 12 or even more spaced apart segments were developed. The segments are generally evenly distributed about the circumference of the gland to distribute the securing force and stress on the pipe. An example of such a three-segment gland is shown in PRIOR ART FIG. 2.

This three-segment gland is a good and cost effective alternative to the more expensive six-segment gland. A common characteristic of two-segment and three-segment glands, is that there is not the same gripping coverage of the six-segment gland. Between each of the consecutive segments on the two, three, and four segment glands is a space that is also bounded by the outer periphery of the pipe and the inner periphery of the gland's pipe opening. For many pipe-types, this space does not pose an issue as the two, three, and four segments are sufficient to secure the pipe to the gland.

In certain other instances, however, the spaces may create issues when certain types of pipes are used. For example, though typical polyvinyl chloride AWWA C900/905 (PVC) pipes work well in two, three, or four segment joint restraint assemblies, a AWWA C909 PVCO pipe may have difficulties. The C909 pipe is made from molecularly-oriented PVC which has lower ring stiffness despite being stronger than C900 material. This makes the particular pipe more difficult to grip than a standard PVC C900/C905 pipe. Because of these characteristics, when securing a gland onto the outer periphery of the C909 pipe the segments may tend to deform the pipe's body which may result in bulges forming between the segments, the effect of this is a weaker joint that might fail under certain circumstances.

Accordingly, illustrative embodiment of the present disclosure is directed to a joint restraint assembly for coupling a pipe to another structure by gripping the outside surface of the pipe. The joint restraint assembly comprises a substantially annular body configured to fit around the pipe; said substantially annular body includes a radially extending gland portion and a circumferentially extending inner peripheral rim portion located adjacent the radially extending gland portion; wherein the radially extending gland portion and the circumferentially extending inner peripheral rim portion form an opening sized to receive the pipe; wherein the circumferentially extending inner peripheral rim portion includes a plurality of pockets, each of the plurality of pockets extends from the circumferentially extending inner peripheral rim portion into the radially extending gland portion; a plurality of segments; wherein each of the plurality of pockets receives one segment of the plurality of segments; wherein each segment of the plurality of segments is configured to engage a portion of the outside surface of the pipe; wherein a space is formed between each pair of consecutive segments of the plurality of segments and adjacent the circumferentially extending inner peripheral rim portion of the substantially annular body; and a plurality of spacers, each of the plurality of spacers is positioned on the circumferentially extending inner peripheral rim portion of the substantially annular body in one of the spaces between the pairs of consecutive segments of the plurality of segments to prevent the outer surface of the pipe from occupying any of the spaces between the pairs of consecutive segments.

In the above and other illustrative embodiments, the joint restraint assembly may further comprise: the circumferentially extending inner peripheral rim portion includes a slot, and the each spacer of the plurality of spacers includes a pilot member that is received in the slot to assist positioning the each spacer of the plurality of spacers on the circumferentially extending inner peripheral rim portion; the substantially annular body being configured to receive first, second, and third segments of the plurality of segments, wherein the plurality of spaces include a first, second, and third spaces, and wherein the first space is located between the first and second segments, the second space located between the second and third segments and the third space is located between the third and first segments; the substantially annular body being configured to receive first and second segments of the plurality of segments, wherein the plurality of spaces include first and second spaces, and wherein the first space is located between the first and second segments, and the second space located between the second and first segments; the plurality of spacers being connected to each other by a band positioned on the circumferentially extending inner peripheral rim portion of the substantially annular body, and wherein the band does not interfere with each segment of the plurality of segments engaging the portion of the outside surface of the pipe; the each of the plurality of spacers includes a pipe engagement surface that is textured to assist with engaging the outer surface of the pipe; the each of the plurality of spacers includes a post configured to engage the substantially annular body to hold the plurality of spacers; the post on each of the plurality of spacers includes at least two biasing legs and at least one foot configured to be biased by at least one of the at least two biasing legs to engage the substantially annular body to hold the plurality of spacers; the each of the plurality of spacers being integrally formed with the substantially annular body; and the plurality of spacers are coupled together by a band, wherein the band does not interfere with the segments engaging the portion of the outside surface of the pipe.

Another illustrative embodiment of the present disclosure is directed to a joint restraint assembly for coupling a pipe to another structure by gripping the outside surface of the pipe. The joint restraint assembly comprise: a substantially annular body configured to fit around the pipe; said substantially annular body includes a radially extending gland portion and a circumferentially extending inner peripheral rim portion located adjacent the radially extending gland portion; wherein the radially extending gland portion and the circumferentially extending inner peripheral rim portion form an opening sized to receive the pipe; wherein the circumferentially extending inner peripheral rim portion includes first, second, and third pockets, each extending from the circumferentially extending inner peripheral rim portion into the radially extending gland portion; first, second, and third segments; wherein each of the first, second, and third pockets receives one of the first, second, and third segments configured to engage a portion of the outside surface of the pipe; wherein a space is formed between the first and second segments, the second and third segments, and third and first segments, all adjacent the circumferentially extending inner peripheral rim portion of the substantially annular body; and wherein a first spacer is located in the space between the first and second segments, a second spacer is located in the space between the second and third segments, and a third spacer is located in the space between the third and first segments, to prevent the outer surface of the pipe from occupying any of the spaces formed between the first and second segments, the second and third segments, and the third and first segments.

Another illustrative embodiment of the present disclosure is directed to a joint restraint assembly for coupling a pipe to another structure by gripping the outside surface of the pipe. The joint restraint assembly comprises a substantially annular body configured to fit around the pipe; said substantially annular body includes a radially extending gland portion and a circumferentially extending inner peripheral rim portion located adjacent the radially extending gland portion; wherein the radially extending gland portion and the circumferentially extending inner peripheral rim portion form an opening sized to receive the pipe; wherein the circumferentially extending inner peripheral rim portion includes first and second pockets, each extending from the circumferentially extending inner peripheral rim portion into the radially extending gland portion; first and second segments; wherein the first and second pockets receive the first and second segments, respectively; wherein the first and second segments are configured to engage a portion of the outside surface of the pipe; wherein a first space is formed between the first and second segments, and a second space is formed between the second and first segments, all adjacent the circumferentially extending inner peripheral rim portion of the substantially annular body; and wherein a first spacer is located in the space between the first and second segments, a second spacer is located in the space between the second and first segments, to prevent the outer surface of the pipe from occupying the first and second spaces formed between the first and second segments and the second and first segments.

Another illustrative embodiment of the present disclosure is directed to a joint restraint assembly for coupling a pipe to another structure by gripping the outside surface of the pipe. the joint restraint assembly that comprises a substantially annular body that includes an opening disposed there through to fit around the pipe, and first, second, and third pockets that receive first, second, and third segments, respectively; wherein the first, second, and third segments are spaced apart from each other; wherein the first, second, and third segments are configured to engage a portion of the outside surface of the pipe; and wherein a first portion of the substantially annular body extends toward the opening between the first and second segments, a second portion of the substantially annular body extends toward the opening between the second and third segments; and a third portion of the substantially annular body extends toward the opening between the third and first segments, to prevent the outer surface of the pipe from occupying any space between the segments.

Another illustrative embodiment of the present disclosure is directed to a joint restraint assembly that comprises: a substantially annular body that includes an opening disposed there through to fit around the pipe, and two or more pockets that each receive a segment configured to engage a portion of the outside surface of the pipe; wherein the segments are spaced apart from each other; and wherein a portion of the substantially annular body extends toward the opening between each of the segments to occupy space between the segments to inhibit deformation of the pipe at the joint restraint assembly.

Another illustrative embodiment of the present disclosure is directed to a joint restraint assembly that comprises: a substantially annular body that includes an opening disposed there through to fit around the pipe, and two or more pockets that each receive a segment, and each segment being spaced apart, consecutively placed, and configured to engage a portion of the outside surface of the pipe; wherein a space is formed between pairs of the spaced apart consecutively placed segments; and a plurality of spacers each located in one of the spaces formed between the pairs of the spaced apart consecutively placed segments to prevent the outer surface of the pipe from occupying any of the spaces formed between pairs of the spaced apart consecutively placed segments.

Additional features and advantages of the joint restraint assembly will become apparent to those skilled in the art upon consideration of the following detailed descriptions exemplifying the best mode of carrying out the joint restraint assembly as presently perceived.

### BRIEF DESCRIPTION OF THE FIGURES

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a front view of a PRIOR ART standard six segment joint restraint assembly;

FIG. 2 is a front view of a PRIOR ART standard three segment joint restraint assembly;

FIG. 3 is a front view of a PRIOR ART standard two segment joint restraint assembly;

FIG. 4 is a front view of a three segment joint restraint assembly according to the present disclosure;

FIG. 5 is an isometric view of the three segment joint restraint assembly;

FIG. 6 is an isometric exploded view of the three segment joint restraint assembly;

FIG. 7 is a front exploded view of the joint restraint assembly;

FIG. 8 is an isometric partially-exploded view of the joint restraint assembly;

FIGS. 9A, 9B, and 9C are perspective, top, and sectional detail views, respectively, of an illustrative spacer;

FIGS. 10A and 10B are cross-sectional and cross-sectional detail views of the joint restraint assembly;

FIG. 11 is a front view of a two-segment joint restraint assembly;

FIGS. 12A, 12B, 12C are perspective, top, and sectional detail views, respectively, of an illustrative spacer;

FIGS. 13A, 13B, 13C are perspective, top, and sectional detail views, respectively, of another illustrative spacer;

FIGS. 14A, 14B, 14C are perspective, elevation, and top views, respectively, of another illustrative spacer;

FIG. 15 is an isometric view of another illustrative embodiment of a joint restraint assembly;

FIG. 16 is an isometric exploded view of another illustrative embodiment of a joint restraint assembly;

FIGS. 17A, 17B, 17C are perspective, front, and side views of a spacer band;

FIGS. 18A, 18B, and 18C are front, cross-sectional detail, and detail views of another illustrative embodiment of a joint restraint assembly; and

FIG. 19 is a cross-sectional detail view of the illustrative embodiment of a joint restraint assembly from FIGS. 18A, 18B, and 18C.

The exemplification set out herein illustrates embodiments of the joint restraint assembly, and such exemplification is not to be construed as limiting the scope of the joint restraint assembly in any manner.

### DETAILED DESCRIPTION OF ILLUSTRATIVE EMBODIMENTS

The present disclosure will be described hereafter with reference to the attached drawings which are given as non-limiting examples. While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but to the contrary, the intention is to cover all modifications, equivalents, and alternatives falling within the spirit and scope of the present disclosure.

An illustrative embodiment of the present disclosure provides a joint restraint assembly that includes a spacer that serves the function of filling-in any space that is created between the outer periphery of a pipe and the gland between spaced apart segments while not requiring more segments to fill those spaces. It is appreciated that spacers may be used with large or small glands having any number of segments. It will be appreciated by the skilled artisan upon reading this disclosure that it contemplates spacers that may be used on any gland that includes two or more consecutive segments (i.e., any plurality of segments) that has a space between them sufficient for a pipe wall to deform into. If the gland includes even six or twelve segments—so long as an appreciable space exists between consecutive segments that allow a pipe to deform into—the spacers of the present disclosure may be used with such glands.

Another illustrative embodiment of the present disclosure provides a spacer having a curved body configured to occupy the space between the outer periphery of the pipe and the inner periphery of the gland's pipe opening and the distance between consecutive segments. In this way, the pipe no longer has room to bulge out between the segments. This results in the pipe better maintaining its original cylindrical shape.

Another illustrative embodiment includes spacers as previously described, but also add a locating rib or appendage located opposite the pipe engagement surface. The locating rib may be configured to fit into a pocket formed in the interior periphery of a gland's internal slot that receives the segments. The rib may be sized and shaped according to the configuration of the pocket as well as positioned on the spacer so that the spacer may be properly located on the gland when receiving the pipe. Additionally, the pipe engagement surface of the gland opposite the pilot rib may be a planar surface or may include any of a plurality of ridges and/or grooves to engage the outer periphery of the pipe as desired. Illustratively, the ribs may be made of a polymer material such as acrylonitrile butadiene styrene (ABS) plastic, metal, ductile, iron, or steel. It is appreciated that the locating rib may be an alternate structure that can be received in bores, channels, or other recessed-type features on the gland to help positively locate the spacer between consecutive segments.

Another illustrative embodiment may include a spacer that is attached or is attachable to the segment, again to fill any gap between consecutive segments. Another illustrative embodiment may include spacers that are attached to, and spaced apart from each other on a ring so that inserting the ring onto the gland will locate all of the spacers in the spaces formed by consecutive segments. Another illustrative embodiment includes spacers that are formed integrally with the gland itself between consecutive segments so the space is filled without having to attach any additional structures.

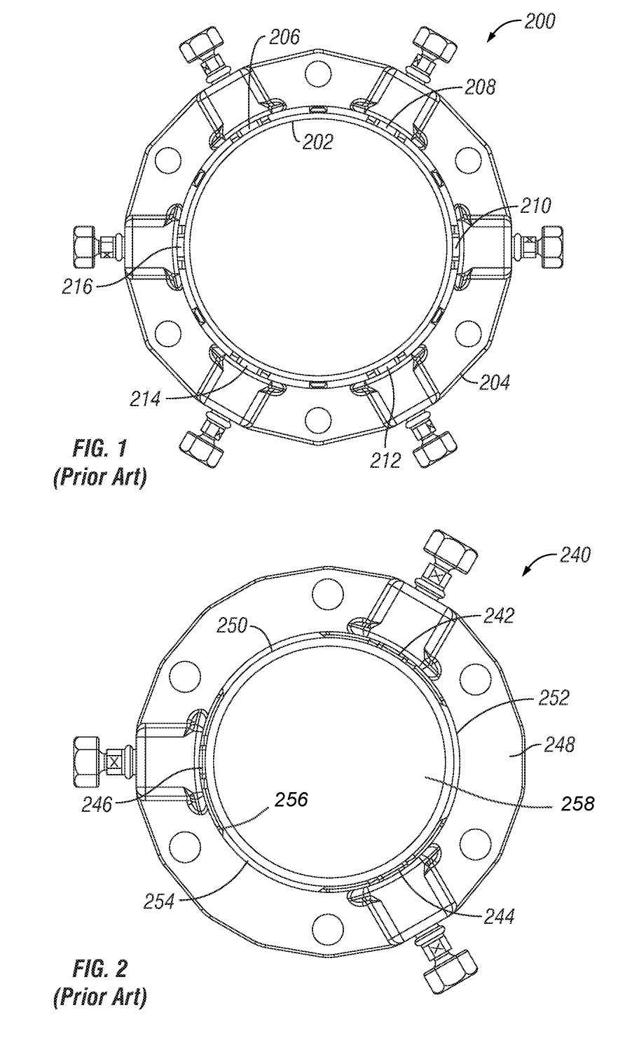

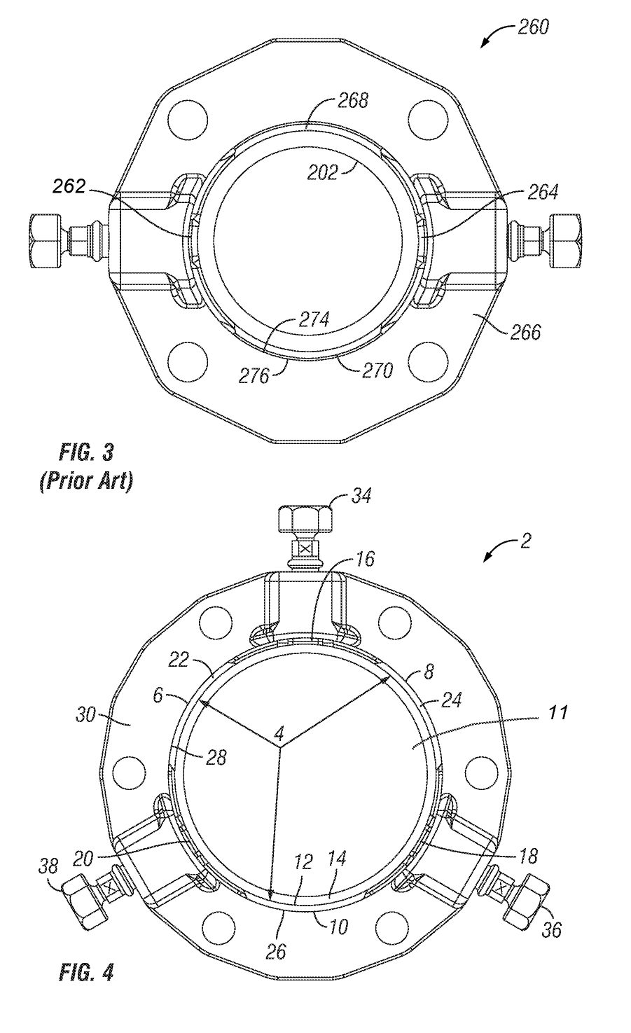

A front view of a PRIOR ART standard joint restraint assembly 200 coupled to a pipe 202 is shown in FIG. 1. This standard joint restraint 200 includes a gland 204 with six (6) segments 206, 208, 210, 212, 214, 216, evenly spaced about gland 204 providing coverage around pipe 202. Also shown are front views of a three segment assembly 240 and two-segment joint restraint assembly 260 in PRIOR ART FIGS. 2 and 3, respectively. In each case, the segments, such as segments 242, 244, 246 (in the case of three segment assembly 240) and segments 262 and 264 (in the case of two segment assembly 260) and are spaced evenly around their respective glands, 248 and 266. Unlike the six-segment restraint 200, large spaces 250, 252, and 254 (in the case of three segment assembly 240) and spaces 268 and 270 (in the case of two segment assembly 260) exist between consecutive segments at the outer periphery of pipe 202 and the inner periphery 256 of the pipe gland opening 258 (in the case of three segment assembly 240) and the inner periphery 274 of the pipe gland opening 276 (in the case of two segment assembly 260). In many instances, these spaces do not pose an issue for the pipes being connected. But, as previously identified, in certain circumstances pipes having particular characteristics may become deformed under a clamping force and pipe pressurization. This deformation may cause the pipe material to occupy the spaces between the segments.

Accordingly, a front view of a three-segment joint restraint assembly 2 is shown in FIG. 4 that includes a spacer system 4 to reduce the openings or voids 6, 8, 10 located adjacent outer periphery 12 of pipe 14 between consecutive segments 16, 18, 20. In the illustrative embodiment, each spacer 22, 24, 26 has a curved body that substantially matches or can be made to match the curve of inner periphery 28 of gland portion 30. Each spacer 22, 24, 26 has a width that illustratively extends from segment to consecutive segment. For example, spacer 22 extends from segment 20 to segment 16; spacer 24 extends from segment 16 to segment 18; and spacer 26 extends from segment 18 to segment 20. As depicted, spacers 22, 24, 26 fill openings 6, 8, 10, respectively between segments leaving substantially no room for pipe 14 to bulge-out and occupy these openings. This assists preventing pipe 14 from deforming, and, thus, maintain its shape.

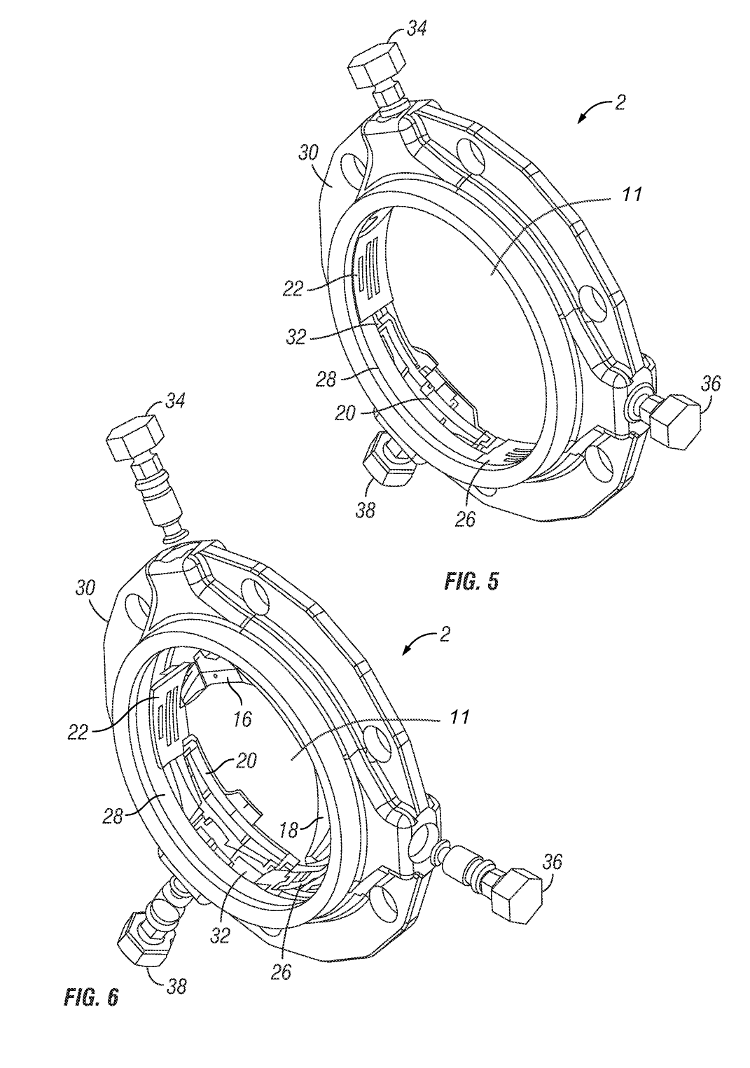

An isometric view of joint restraint assembly 2 is shown in FIG. 5. This view, similar to FIG. 4, shows gland 30 on inner periphery 28. Seated within inner periphery 28 are segments, 16 (not shown in this view), 18 (not shown in this view) and 20. In this illustrative embodiment, a pocket or slot 32 is formed within inner periphery. 28 to receive segments 16, 18, and 20. Bolts 34, 36, and 38 act on their respective segments 16, 18, 20, in order to cause the segments to engage the outer periphery 12 of pipe 14. Further, disclosure on this engagement between the segments and the pipe may be found in the '273 patent previously incorporated herein by reference. To that end, it is the segments and bolts that create the positive engagement on the pipe, such as pipe 14 in order to hold the gland 30, and hence joint restraint assembly 2, onto pipe 14. This is distinguishable from spacers 22, 24, 26 which fit and opening 6, 8, 10, respectively (see FIG. 4). In order to occupy the space created by said openings to physically prevent pipe 14 from deforming to the extent that it can occupy the space created by openings 6, 8, 10.

And isometric exploded view of joint restraint assembly 2 is shown in FIG. 6. This view further shows how bolts, 34, 36, 38 fit into gland 30 to engage segments 16, 18, 20, respectively. It will be appreciated by the skilled artisan upon reading this disclosure how segments 16, 18, 20 fit into slot or pocket 32, and then apply a holding force against pipe 14 (see, also, FIG. 4). Accordingly, pipe 14 or other similar pipe, particularly one that may be subject to deformation under certain circumstances may be disposed through pipe opening 11. Segments 16, 18, 20 engage outer periphery 12 of pipe 14 to hold pipe 14 in place. Spacers 22, 24, 26 are located between said segments in openings 6, 8, 10, respectively. Openings 6, 8, 10 (see FIG. 4) are also between outer periphery 12 of pipe 14 and inner periphery 28 of gland 30 to prevent the deformation.

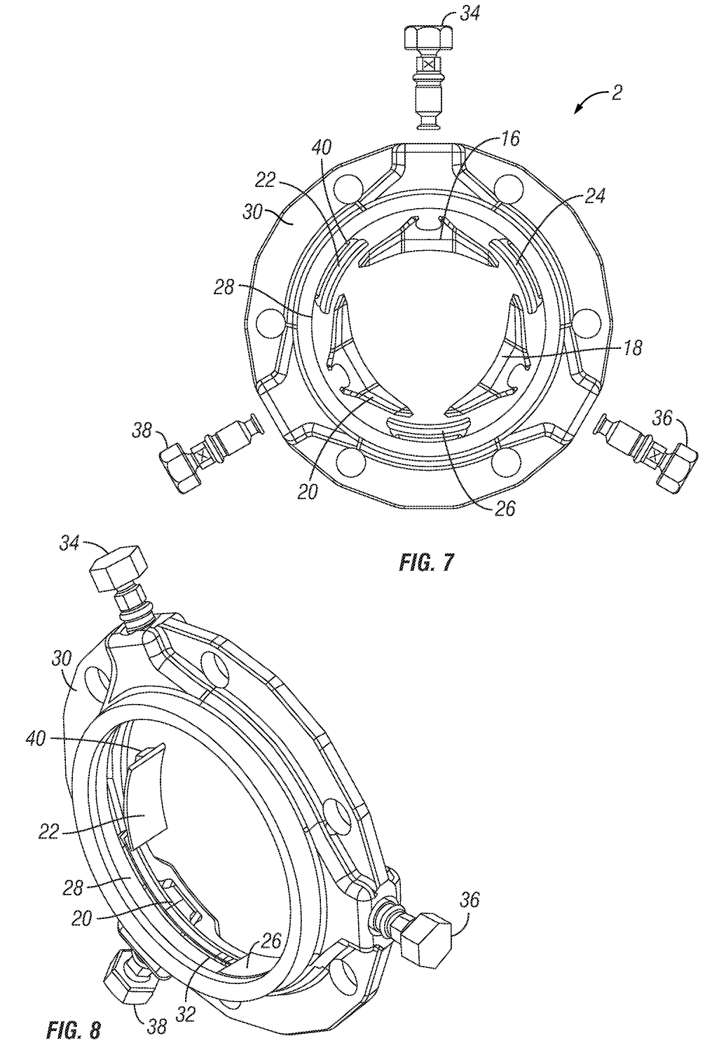

The similar exploded view of joint restraint assembly 2 is shown in FIG. 7. This view further demonstrates how segments 16, 18, 20 are positionable in pipe opening 11 formed by inner periphery 28 of gland 30. In addition, and is discussed further herein, each spacer 22, 24, 26, may include a pilot rib 40 in order to positively seat in slot or pocket 32 of inner periphery 28 (see, also, FIGS. 5 and 6).

Another isometric partially-exploded view of joint restraint assembly 2 is shown in FIG. 8. Here, segment 20 is shown located in slot or pocket 32 of inner periphery 28. Spacer 22 is shown being removable from slot or pocket 32. It is appreciated that all of the spacers in this embodiment may be removable from the inner periphery 28 of gland 30. In other embodiments, the spacer may be affixed to or integrally formed into gland 30.

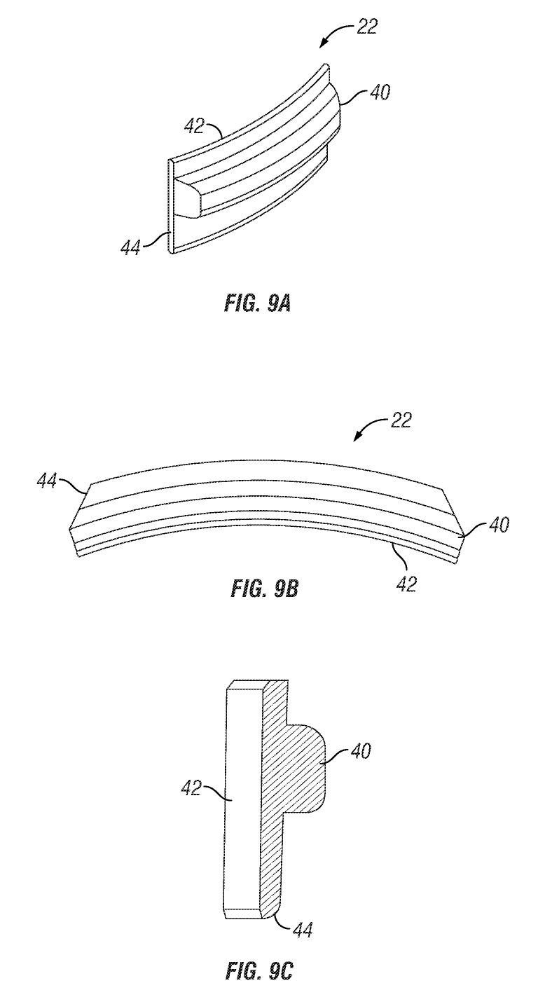

FIGS. 9A, 9B, and 9C, show perspective, top, and cross-sectional detail views of an illustrative spacer 22. It will be appreciated by the skilled artisan upon reading this disclosure that although the present description is being made with respect to spacer 22, that description may be applied to spacers 24 and 26 as well. In an illustrative embodiment, all of the spacers may be identical. In an alternate embodiment, however, the spacers may include differing characteristics that may be needed in order to successfully fill the space between consecutive segments and outer periphery 12 of pipe 14 (when installed) and inner periphery 28 of gland 30 to prevent pipe deformation.

As shown in FIG. 9A, spacer 22 includes a pipe engagement surface 42. As the name implies, this side of spacer 22 engages outer periphery 12 of pipe 14 (see, also, FIG. 4). Spacer 22 includes a body 44 having a thickness and width sufficient to occupy the space between outer periphery 12 and inner periphery 28. It is appreciated that spacer 22 (as well as spacers 24 and 26) may be made of a resilient other like material that allows for an amount of bending or give to ensure the space is filled between the pipe and the gland while at the same time, not allowing for a substantial amount of deformation to occur in the pipe that itself would occupy the space (i.e., openings 6, 8, 10). In other embodiments, spacer 22 may be made of a more rigid formed material, such as a polymer or metal. Also shown in this view is pilot or locating rib 40 as previously identified sized and shaped to fit into a portion of slot or pocket 32 formed in inner periphery 28 of gland 30. Pilot rib 40 is illustratively positioned opposite engagement surface 42. Illustratively, pipe engagement surface 42 may be a smooth surface. In other embodiments, however, the spacer may be configured to include rib—flat, roughened, or other irregular surface to assist facilitating attachment or gripping the pipe to the pipe joint assembly. It is also appreciated that spacers 22, 24, 26, and their corresponding pilot ribs are configured to engage standard three-segment glands and pockets used in conventional three-segment pipe joint assemblies. Furthermore, other piloting ribs or no piloting rib at all may be used. The segments may be alternately configured to fit into other slots or pockets of other pipe joint assemblies, whether two-segment, three-segment, etc.

The view shown in FIG. 9B is a top view of spacer 22 further showing pipe engagement surface 42 and piloting rib 40. This view further illustrates the arcuate character of pipe engagement surface 42. Again, it is appreciated that such arcuate surface may be performed in the manufacture of spacer 22, or alternatively formed when spacer 22 is fitted onto inner periphery 28 of gland 30 and is flexible to conform to the curved shape of inner periphery 28. Likewise, as shown in the detail view of FIG. 9C, piloting rib 40 is shown extending opposite pipe engagement surface 42. Also appreciated from this view is the thickness of body 44 that is intended to occupy opening 6 between outer periphery 12 of pipe 14 inner periphery 28 of gland 30.

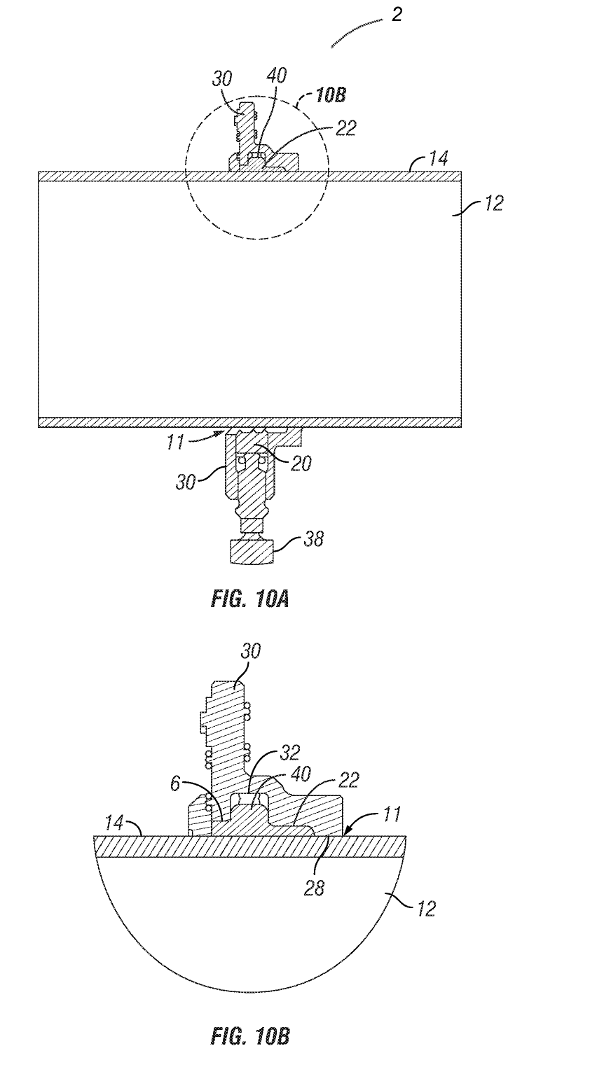

Side cross-sectional and cross-sectional detail views of joint restraint assembly 2 affixed to pipe 14 with spacer 22 filling opening 6 between inner periphery 28 of gland 30, and outer periphery 12 of pipe 14 are shown in FIGS. 10A and 10B, respectively. As shown in FIG. 10A, pipe 14 is fitted in pipe opening 11 of joint restraint assembly 2 and secured therewith by segment 20 and bolt 38 engaging outer periphery 12 of pipe 14. It is appreciated that all of the bolts and segments, including bolts 34, 36 and segments 16 and 18, operate to engage and hold pipe 14 onto assembly 2. In addition, spacer 22 (which operates the same as spacers 24 and 26) fills opening 6 (as openings 8 and 10 would be filled by spacers 24 and 26, respectively).

The detail cross-sectional view in FIG. 10B, further illustrates slot or pocket 32 formed in inner periphery 28 of gland 30. Pocket 32 receives locating rib 40 to hold spacer 22 in place during assembly as well as insures spacer 22 is positioned properly. It is further appreciated in this view how spacer 22 occupies any open space in opening 6 which prevents pipe 14 from being able to deform and otherwise occupy that same space. It is appreciated, and as discussed previously, the shape, size, and configuration of the spacer may be adjusted based on the configuration of the gland, segments, and pipe. In any such configuration, the objective is still to fill or occupy any space that may exist between the gland and the pipe not already occupied by the gripping segments to prevent any portion of the pipe that might otherwise be able to deform and occupy that space from doing so.

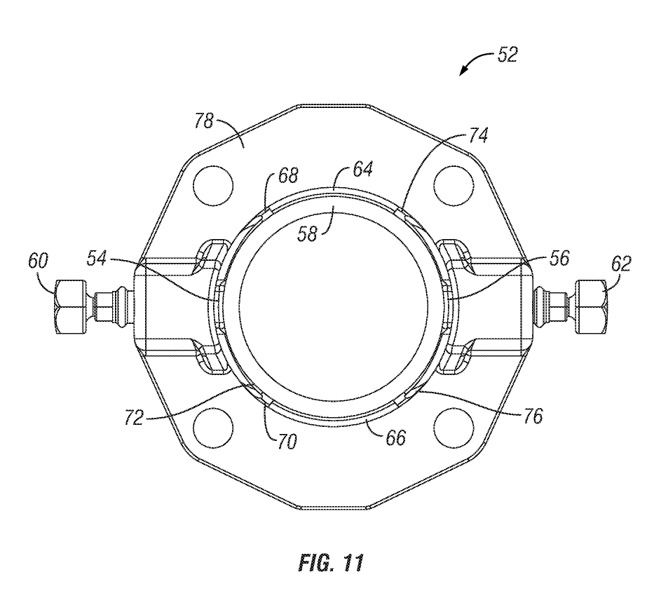

The views of FIGS. 11-14 depict another illustrative embodiment of the present disclosure. In this illustrative embodiment, joint restraint assembly 52 is shown having only two segments 54 and 56 located opposite each other and cause to engage pipe 58 via bolts 60 and 62. In this case, there is relatively more space that exists between the segments than what may exist between a three-segmented joint restraint assembly. Accordingly, here spacers 64 and 66 are located in openings 68 and 70, respectively, to occupy those spaces and prevent outer periphery 72 of pipe 58 from being deformable into any unoccupied space in openings 68 or 70. Similar to the prior embodiment, joint restraint assembly 52 includes a pipe opening 74 defined by inner periphery 76 of gland 78. Also similar to the prior embodiment, by including spacers 64 and 66 to occupy the space in openings 68 and 70, respectively, pipe 58 has no place to deform.

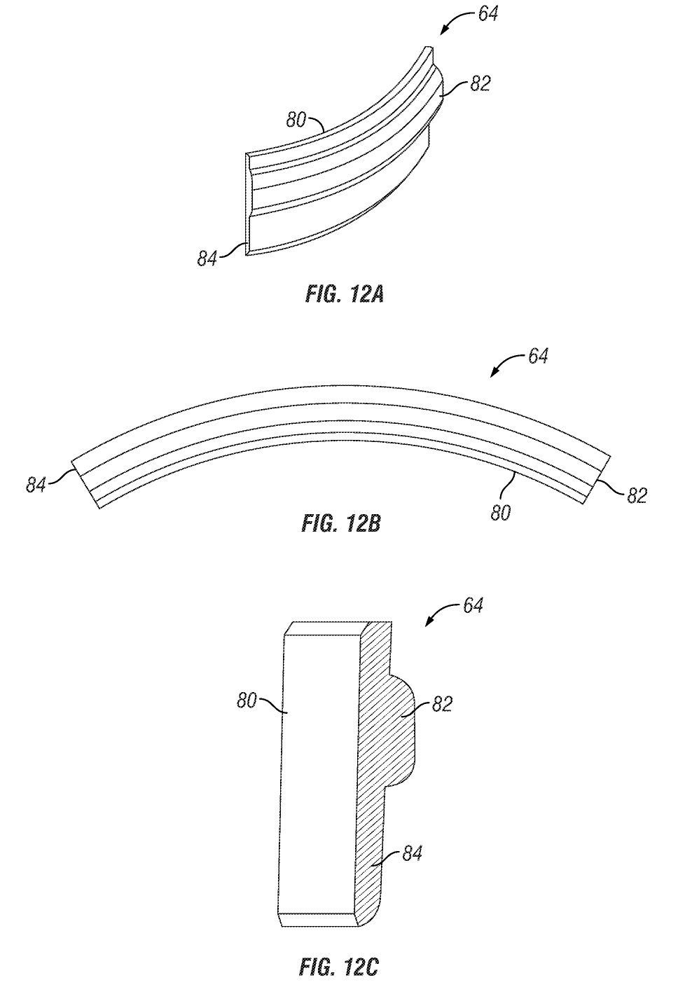

Also similar to the prior embodiment, illustrative perspective, top, and detailed sectional views of spacer 64 is shown and FIGS. 12A, 12B, and 12C. Spacer 64 includes a pipe engagement surface 80, pilot rib 82, and body 84 located between pipe engagement surface 80 and pilot rib 82. Pipe engagement surface 80 is configured to engage outer periphery 72 of pipe 58 and may have a flat, roughened, or ribbed surface as desired to engage pipe 58. Pilot rib 82 may likewise be configured to be received into a pocket or slot formed in inner periphery 76 of gland 78 (see, also, FIG. 11). Again, it will be appreciated by the skilled artisan upon reading the disclosure that pilot rib 82 may be sized and shaped to fit into slots or pockets that already exist in conventional joint restraint glands. In this and other embodiments, pilot rib 82 may have a different size or shape so it may be accommodated in the current gland slots while still positioning body 84 in any opening formed between consecutive segments, the outer periphery of a held pipe and the inner periphery of the gland.

Similarly, the views in FIGS. 12B and 12C show the curved surface of pipe engagement surface 80 as well as body 84. It is appreciated that these spacers may be made from a metal or polymer material. It is further appreciated that any variety of materials may be used so long as the held pipe will be resisted from deforming because of the spacers presence between consecutive segments. Also shown in FIG. 12C is an illustrative profile of piloting rib 82 that fits in a pocket of the inner periphery of the gland.

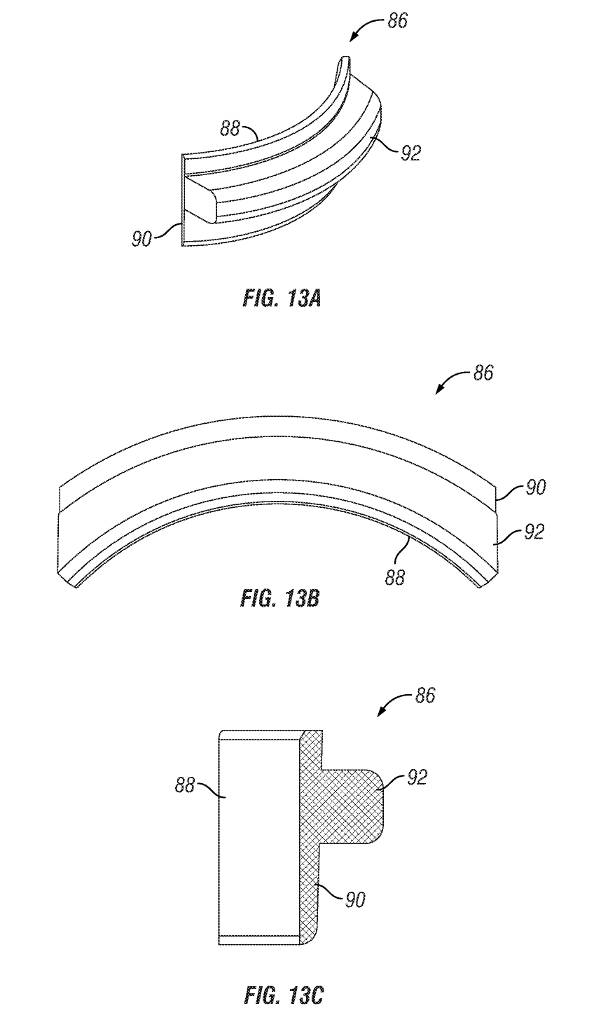

Perspective, top, and detail elevation views of another illustrative embodiment of a spacer 86 are shown in FIGS. 13A, 13B, and 13C. This embodiment further demonstrates the variety of configurations the spacer may be formed in to accommodate the particular joint restraint assembly and pipe. For example, spacer 86 may be used for a 3-inch nominal-size pipe to accommodate a corresponding pipe joint assembly gland. The arcuate surface 88, body 90, and pilot rib 92 operate similar to those structures previously discussed with respect to other spacer embodiments. Additionally, the radius of the arcuate body 90 and pipe engagement surface 88 may be tighter to accommodate the smaller diameter pipe. Further, pilot rib 92 as particularly highlighted in FIGS. 13A and 13C demonstrate to one skilled in the art that it may be configured to be received in a slot of the inner periphery of the gland.

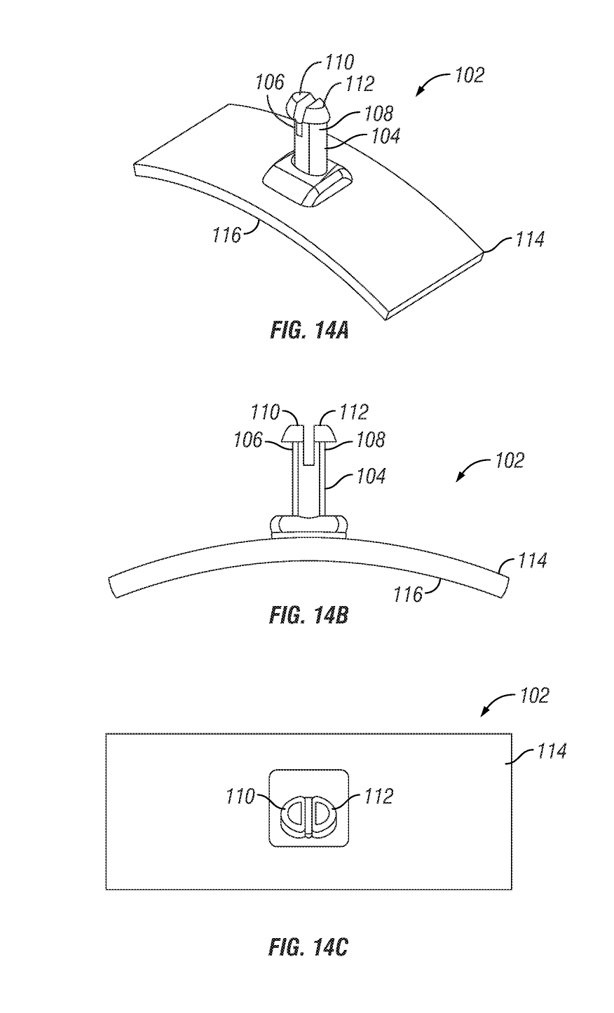

Another illustrative embodiment of the present disclosure of a spacer 102 is shown in FIGS. 14A, 14B, and 14C. A distinction in this embodiment is that spacer 102 includes a pilot post 104. Such post 104 illustratively includes leg portions 106 and 108 and feet portions 110 and 112. Spacer 102 still includes a body 114 and pipe engagement surface 116 that operate similar to the prior spacer embodiments. In this particular embodiment, however, pilot post 104 is configured to be disposed in a bore formed in the gland (not shown). Biasing legs 106, 108 fit into such bore and may be separated from each other to create an outward bias. Feet 110 and 112 may be configured such that when legs 106 and 108 extend beyond the bores and, the feet hook onto the end of the bore. The outward bias created by the legs keep the post coupled to the gland.

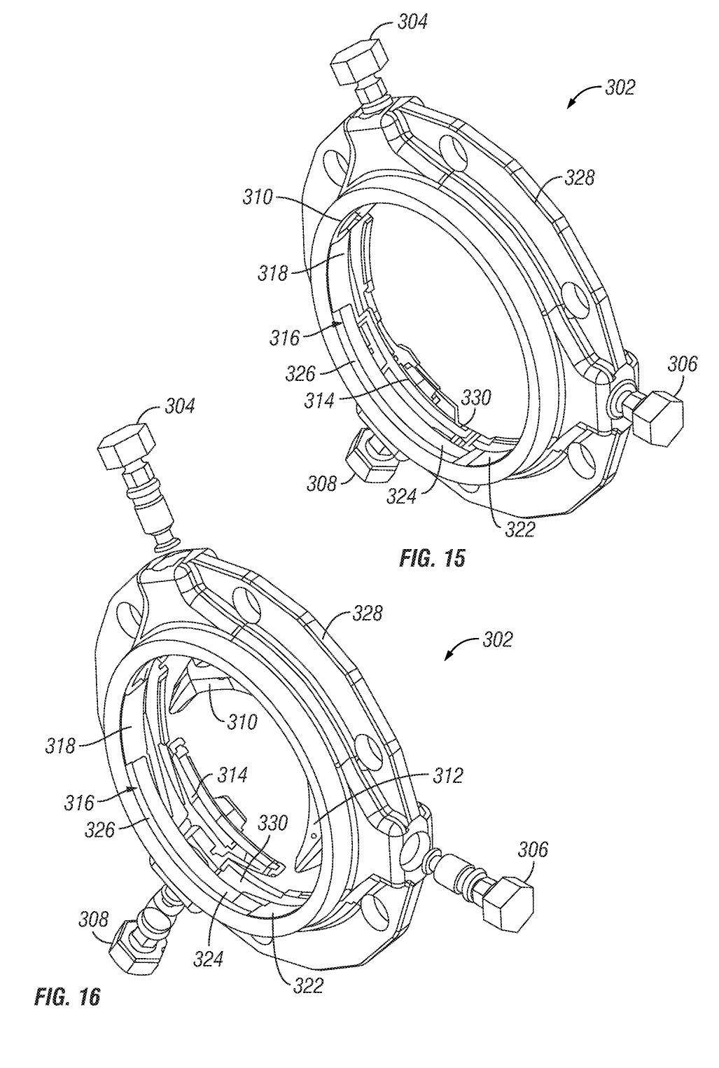

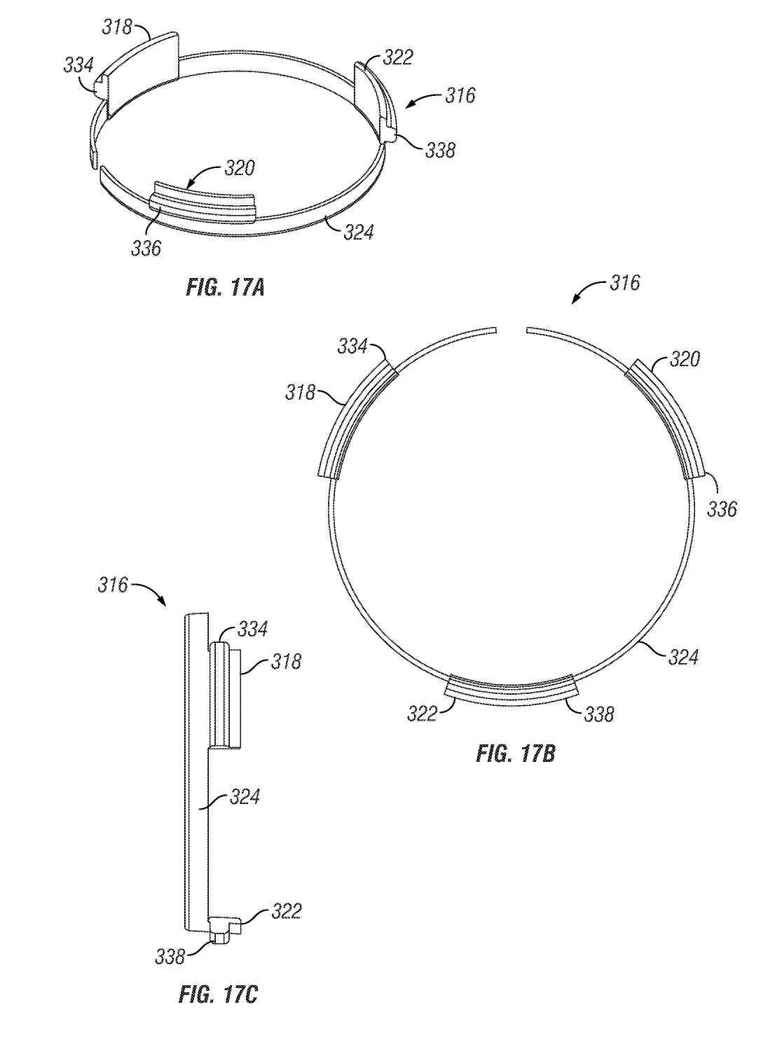

FIGS. 15-18 disclose another illustrative embodiment of a joint restraint assembly, 302. This illustrative embodiment of joint restraint assembly 302 is a three-segment design that includes bolts 304, 306, 308 that move segments 310, 312 (not shown in this view) and 314. This embodiment differs from joint restraint assembly 2 in that a spacer ring 316 is employed to provide the spacers between segments 310, 312 and 314. Illustratively, spacer portions 318, 320 (see FIG. 17A), and 322 are joined together via a band 324. Band 324 is connected to spacers 318, 320, and 322 to form a ring. Illustratively, band 324 is placed adjacent each segment with the spacers attached and located between consecutive spacers. It is contemplated that band 324 is conformable to the shape of the inner periphery 326 of gland 328 of joint restraint assembly 302. This allows easier assembly wherein one ring may be inserted onto inner periphery 326. This essentially installs all three spacers at one time providing enhanced ease of installation.

An isometric exploded view of joint restraint assembly 302 is shown in FIG. 16. This view is similar to that of FIG. 15 except segments 310, 312, 314 are shown separated from bolts 304, 306, 308. Spacer ring 316 fits into inner periphery 326 of gland 328. Slot or pocket 330, similar to the prior embodiments, is configured to receive the pilot ribs on the spacers. This allows for positive placement of all spacers 318, 320 and 322 by just inserting one spacer ring 316.

Perspective, front, and side views of spacer ring 316 are shown in FIGS. 17A, 17B, 17C, respectively. All of these views show spacers 318, 320, and 322 tied together via band 324 as illustratively shown. In this embodiment, and as previously discussed, pilot ribs 334, 336, 338 formed on spacers 318, 320, and 322, respectively, fit into the pocket or slot of the inner periphery of the gland of the joint restraint assembly pursuant to the foregoing disclosures.

The view in FIG. 17B depicts illustrative placement of spacers 318, 320, 322 on band 324 of spacer ring 316 configured for a three-segment joint restraint assembly of the type previously discussed. It is appreciated, however, that the arrangement of the spacers, as well as the number of them, may be reconfigured to be employed with glands accommodating more or less segments. This view also further shows pilot ribs 334, 336 and 338. The side view of ring spacer 316 shown in FIG. 17C further illustrates how the spacers such as spacer 318 and 322 are configured to fill the space between the inner periphery of the gland and the outer periphery of the of the pipe as previously discussed. In addition, band 324 as shown in FIGS. 15 and 16, for example, may illustratively be narrower than the corresponding spacers so it does not interfere with the segments gripping onto the pipe. It is contemplated that the ring is conformable to the shape of the inner periphery of the gland's pipe opening and the spacers are attached at locations on that ring that coincide to the space between each of the consecutive segments. In an illustrative embodiment, the ring may not form a full circle but may instead be made of a biasing material such as a polymer so the ring's diameter can be reduced to fit the spacers into the gland. In particular, if the spacers include locating ribs, the ring may be collapsed a sufficient amount to allow the ribs to clear the diameter of the gland's pipe opening. With resiliency in the ring, once the spacers are located in place, the ring may spring back to its intended diameter having the effect of pushing the locating ribs into the pockets of the gland and securing the ring spacer in place.

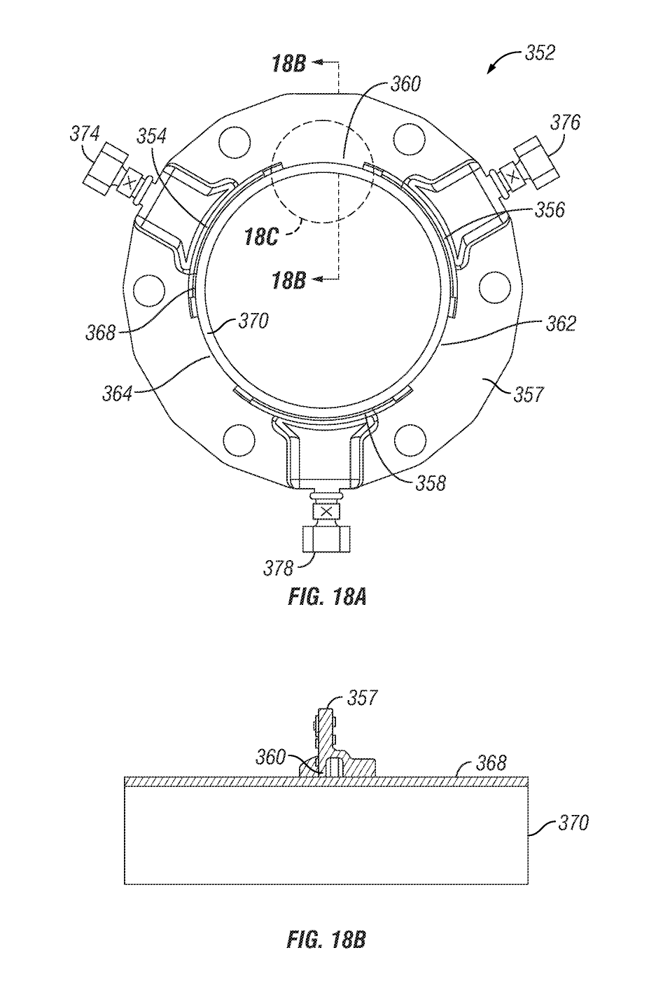

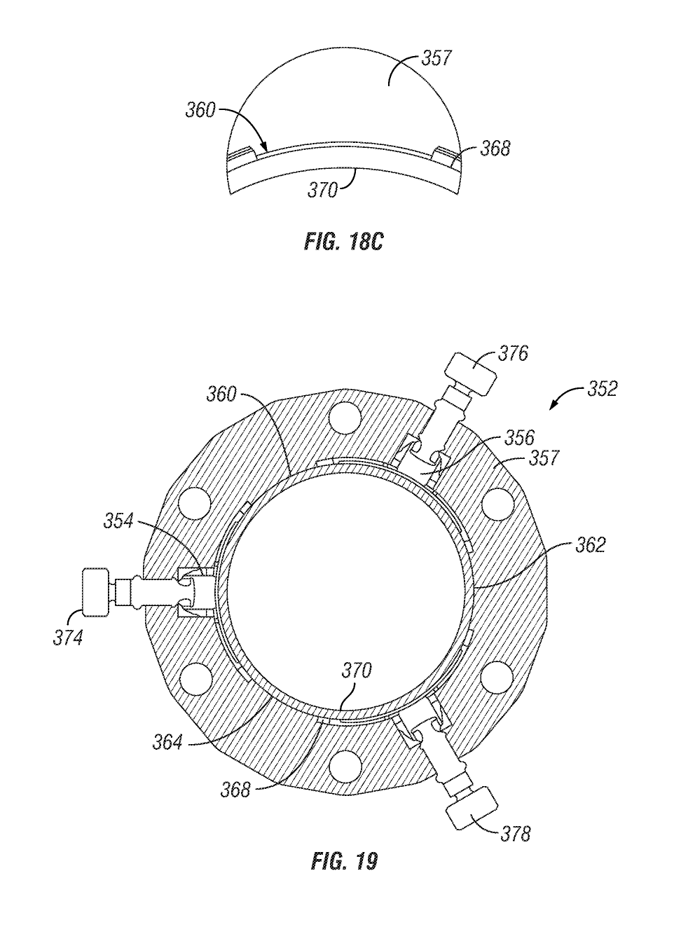

Another illustrative embodiment of the present disclosure is shown by the front view of joint restraint assembly 352 shown in FIGS. 18A, 18B, 18C, and 19. This embodiment illustratively includes three segments 354, 356 and 358 similar to the previously discussed three-segment glands. In contrast, however, gland 357 of joint restraint assembly 352 includes integrally formed spacers in gland 357.

As shown in the detail views of FIGS. 18B, 18C, gland 357 includes a spacer portion 360 configured to engage outer periphery 368 of pipe 370. The concept is the same as the prior spacers where spacer 360 occupies any space that may exist between outer periphery 368 of pipe 370 and gland 357 by filling in that space between consecutive segments. In this case, however, joint restraint assembly 352 does not require any separate spacers to be installed. Rather, the integrally formed spacers 360, 362, and 364, are already part of the assembly. All that needs to happen is segments 354, 356, 358, to engage and tighten down onto pipe 370 in conventional manner. These integrally-formed spacers, if made of the same material as the gland which is typically ductile iron, are very strong and should assist preventing the pipe being substantially deformed even when subjected to the force of the segments.

As shown in the elevational cut away view of joint restraint assembly 352, in FIG. 19, bolts 374, 376, 378 engaging segments 354, 356, and 358, respectively, which engage and hold pipe 370. But instead of then installing separate spacers or a spacer ring, gland 357 include spacers 360, 362, and 364 integrally formed and abutting pipe 370 to prevent it from deforming under a load. It will be appreciated by the skilled artisan upon reading the present disclosure that in the foregoing embodiments that the tolerances needed between the pipe and the gland's pipe opening, the spacers may allow some de minimus amount of clearance between them and the outer periphery of the pipe. It is believed, however, that in such circumstances the clearance will not hinder operation of the pipe joint assembly and only allow a minimal and insubstantial amount of deformation that would not impair the ability of the pipe joint to properly function.

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the present disclosure.

What is claimed is:

1. A joint restraint assembly for coupling a pipe to another structure by gripping the outside surface of the pipe, the joint restraint assembly comprising:
a substantially annular body configured to fit around the pipe;
said substantially annular body includes a radially extending gland portion and a circumferentially extending inner peripheral rim portion located adjacent the radially extending gland portion;
wherein the radially extending gland portion and the circumferentially extending inner peripheral rim portion form an opening sized to receive the pipe;
wherein the circumferentially extending inner peripheral rim portion includes a plurality of pockets, each of the plurality of pockets extends from the circumferentially extending inner peripheral rim portion into the radially extending gland portion;
a plurality of segments;
wherein each of the plurality of pockets receives one segment of the plurality of segments;
wherein each segment of the plurality of segments is configured to engage a portion of the outside surface of the pipe;
wherein a space is formed between each pair of consecutive segments of the plurality of segments and adjacent the circumferentially extending inner peripheral rim portion of the substantially annular body; and
a plurality of spacers, each of the plurality of spacers is positioned on the circumferentially extending inner peripheral rim portion of the substantially annular body in one of the spaces between the pairs of consecutive segments of the plurality of segments to prevent the outer surface of the pipe from occupying any of the spaces between the pairs of consecutive segments.

2. The joint restraint assembly of claim 1, wherein the circumferentially extending inner peripheral rim portion includes a slot, and the each spacer of the plurality of spacers includes a pilot member that is received in the slot to assist positioning the each spacer of the plurality of spacers on the circumferentially extending inner peripheral rim portion.

3. The joint restraint assembly of claim 1, wherein the substantially annular body is configured to receive first, second, and third segments of the plurality of segments, wherein the plurality of spaces include a first, second, and third spaces, and wherein the first space is located between the first and second segments, the second space located between the second and third segments and the third space is located between the third and first segments.

4. The joint restraint assembly of claim 1, wherein the substantially annular body is configured to receive first and second segments of the plurality of segments, wherein the plurality of spaces include first and second spaces, and wherein the first space is located between the first and second segments, and the second space located between the second and first segments.

5. The joint restraint assembly of claim 1, wherein the plurality of spacers are connected to each other by a band positioned on the circumferentially extending inner peripheral rim portion of the substantially annular body, and wherein the band does not interfere with each segment of the plurality of segments engaging the portion of the outside surface of the pipe.

6. The joint restraint assembly of claim 1, wherein the each of the plurality of spacers includes a pipe engagement surface that is textured to assist with engaging the outer surface of the pipe.

7. The joint restraint assembly of claim 1, wherein the each of the plurality of spacers includes a post configured to engage the substantially annular body to hold the plurality of spacers.

8. The joint restraint assembly of claim 7, wherein the post on each of the plurality of spacers includes at least two biasing legs and at least one foot configured to be biased by at least one of the at least two biasing legs to engage the substantially annular body to hold the plurality of spacers.

9. The joint restraint assembly of claim 1, wherein the each of the plurality of spacers is integrally formed with the substantially annular body.

10. A joint restraint assembly for coupling a pipe to another structure by gripping the outside surface of the pipe, the joint restraint assembly comprising:
a substantially annular body configured to fit around the pipe;
said substantially annular body includes a radially extending gland portion and a circumferentially extending inner peripheral rim portion located adjacent the radially extending gland portion;
wherein the radially extending gland portion and the circumferentially extending inner peripheral rim portion form an opening sized to receive the pipe;
wherein the circumferentially extending inner peripheral rim portion includes first, second, and third pockets, each extending from the circumferentially extending inner peripheral rim portion into the radially extending gland portion;
first, second, and third segments;
wherein each of the first, second, and third pockets receives one of the first, second, and third segments configured to engage a portion of the outside surface of the pipe;
wherein a space is formed between the first and second segments, the second and third segments, and the third and first segments, all adjacent the circumferentially extending inner peripheral rim portion of the substantially annular body; and
wherein a first spacer is located in the space between the first and second segments, a second spacer is located in the space between the second and third segments, and a third spacer is located in the space between the third and first segments, to prevent the outer surface of the pipe from occupying any of the spaces formed between the first and second segments, the second and third segments, and the third and first segments.

11. A joint restraint assembly for coupling a pipe to another structure by gripping the outside surface of the pipe, the joint restraint assembly comprising:
a substantially annular body configured to fit around the pipe;
said substantially annular body includes a radially extending gland portion and a circumferentially extending inner peripheral rim portion located adjacent the radially extending gland portion;
wherein the radially extending gland portion and the circumferentially extending inner peripheral rim portion form an opening sized to receive the pipe;
wherein the circumferentially extending inner peripheral rim portion includes first and second pockets, each extending from the circumferentially extending inner peripheral rim portion into the radially extending gland portion;
first and second segments;
wherein the first and second pockets receive the first and second segments, respectively;
wherein the first and second segments are configured to engage a portion of the outside surface of the pipe;
wherein a first space is formed between the first and second segments, and a second space is formed between the second and first segments, all adjacent the circumferentially extending inner peripheral rim portion of the substantially annular body; and
wherein a first spacer is located in the space between the first and second segments, a second spacer is located in the space between the second and first segments, to prevent the outer surface of the pipe from occupying the first and second spaces formed between the first and second segments and the second and first segments.

12. A joint restraint assembly for coupling a pipe to another structure by gripping the outside surface of the pipe, the joint restraint assembly comprising:
a substantially annular body that includes an opening disposed there through to fit around the pipe, and first, second, and third pockets that receive first, second, and third segments, respectively;
wherein the first, second, and third segments are spaced apart from each other;
wherein the first, second, and third segments are configured to engage a portion of the outside surface of the pipe; and
wherein a first portion of the substantially annular body extends toward the opening between the first and second segments, a second portion of the substantially annular body extends toward the opening between the second and third segments; and a third portion of the substantially annular body extends toward the opening between the third and first segments, to prevent the outer surface of the pipe from occupying any space between the segments.

13. A joint restraint assembly for coupling a pipe to another structure by gripping the outside surface of the pipe, the joint restraint assembly comprising:
a substantially annular body that includes an opening disposed there through to fit around the pipe, and two or more pockets that each receive a segment configured to engage a portion of the outside surface of the pipe;
wherein the segments are spaced apart from each other; and
wherein a portion of the substantially annular body extends toward the opening between each of the segments to occupy space between the segments to inhibit deformation of the pipe at the joint restraint assembly.

14. A joint restraint assembly for coupling a pipe to another structure by gripping the outside surface of the pipe, the joint restraint assembly comprising:
a substantially annular body that includes an opening disposed there through to fit around the pipe, and two or more pockets that each receive a segment, and each segment being spaced apart, consecutively placed, and configured to engage a portion of the outside surface of the pipe;
wherein a space is formed between pairs of the spaced apart consecutively placed segments; and
a plurality of spacers each located in one of the spaces formed between the pairs of the spaced apart consecutively placed segments to prevent the outer surface of the pipe from occupying any of the spaces formed between pairs of the spaced apart consecutively placed segments.

15. The joint restraint assembly of claim 14, wherein the plurality of spacers are couple together by a band, wherein the band does not interfere with the segments engaging the portion of the outside surface of the pipe.
